(19) United States
(12) Patent Application Publication
(10) Pub. No.: US 2009/0103488 A1
(43) Pub. Date: Apr. 23, 2009

(54) PRACTICAL METHOD FOR RESOURCE ALLOCATION FOR QOS IN OFDMA-BASED WIRELESS SYSTEMS

(75) Inventors: Chenxi ZHU, Gaithersburg, MD (US); Tolga Girici, Ankara (TR); Jonathan Agre, Brinklow, MD (US); Anthony Ephremides, Bethesda, MD (US)

Correspondence Address: STAAS & HALSEY LLP, SUITE 700, 1201 NEW YORK AVENUE, N.W., WASHINGTON, DC, 20005, US

(73) Assignees: University Of Maryland, Collage Park, MD (US); Fujitsu Limited, Kawasaki (JP)

(21) Appl. No.: 12/164,838

(22) Filed: Jun. 30, 2008

Related U.S. Application Data
(60) Provisional application No. 60/946,768, filed on Jun. 28, 2007.

(51) Int. Cl. H04W 72/08

(52) U.S. Cl. 370/330; 370/329

(57) ABSTRACT

A data communication resource allocation for OFDMA based wireless systems supporting heterogeneous traffic is provided by allocating the rates to users subject to power/bandwidth constraints, according to a user selection metric and rate allocation based on traffic requirements and channel conditions. Thus, a proportionally fair rate allocation with minimum rate constraint to data sessions and short term rate guarantees to real-time sessions can be provided.

### CROSS-REFERENCE TO RELATED APPLICATION(S)

This application is related to and claims priority to U.S. provisional application entitled PRACTICAL METHOD FOR RESOURCE ALLOCATION FOR QOS IN OFDMA-BASED WIRELESS SYSTEMS having Ser. No. 60/946,768 filed Jun. 28, 2007 and incorporated by reference herein.

### BACKGROUND

1. Field

An aspect of an embodiment of the invention relates to resource allocation for Quality of Service (QoS) in Orthogonal Frequency-Division Multiplexing (OFDM) based wireless communication systems.

2. Description of the Related Art

Wireless transmission systems based on Orthogonal Frequency-Division Multiple Access (OFDMA), such as (without limitation) IEEE 802.16e, are being developed for commercial applications. OFDMA schemes allow multiple users to concurrently transmit in the same time slot by sharing the bandwidth and power. This provides more flexibility in terms of resource assignment than traditional schemes like Time Division Multiple Access (TDMA) or Code Division Multiple Access (CDMA). The job of the scheduling algorithm at the Base Station (BS) is to choose an allocation of subchannels for users and to allocate power levels to these users. Often it might be necessary to satisfy certain Quality of Service (QoS) requirements for certain service flows, like Voice over Internet Protocol (VoIP) or Video. The scheduling needs to balance individual QoS levels and “fairness” among the users and to also maximize system capacity.

Broadband wireless networks are designed to be able to provide high rate and heterogeneous services to mobile users that have various quality of service (QoS) requirements. In recent years several broadband air interface technologies have been developed to provide Internet access multimedia services to end users. Two notable examples of broadband wireless technologies are 3GPP and mobility mode of IEEE 802.16 WirelessMAN Air Interface standard, commonly referred to as Mobile WiMax (802.16e). Based on the recently developed IEEE 802.16e standard, WiMax is a cellular network, where a Base Station (BS) connects mobile stations (MS) to various networks linked to the BS. See papers [1] and [2] by IEEE 802.16 2004, Amendment to IEEE Standard for Local and Metropolitan Area Networks—Part 16: Air Interface for Fixed Broadband Wireless Access Systems, IEEE, October 2004; and IEEE 802 16e, IEEE Standard for Local and Metropolitan Area Networks, Part 16: Air Interface for Fixed and Mobile Broadband Wireless Access Systems, Amendment 2: Physical and Medium Access Control Layers for Combined Fixed and Mobile Operation in Licensed Bands and Corrigendum 1, IEEE, February 2006. Transmissions in Long Term Evolution (3GPP) and 802.16-based wireless technologies are based on OFDM, where several modulation, coding and power allocation schemes are allowed to give more degrees of freedom to resource allocation. See papers [3] and [4], respectively, by A. Ghosh, D. Wolter, J. G. Andres, and R Chen, Broadband Wireless Access with WiMax/802.16: Current Performance Benchmarks and Future Potential, IEEE Communications Magazine, February 2005; and C. Eklund, R. B. Marks, K. L. Stanwood, and S. Wang, IEEE Standard 802.16: A Technical Overview of the WirelessMAN Air Interface for Broadband Wireless Access, IEEE Communications Magazine, June 2002.

Fully taking advantage of this degree of freedom is an important problem and has been studied previously in papers [5], [6], [7], [8]. [9], and [10] by C. Y. Wong, R. S. Cheng, K. B. Letaief, and R. D. Murch, Multiuser Subcarrier Allocation for OFDM Transmission using Adaptive Modulation, Vehicular Technology Conference, 1999 IEEE 49^{th}, pages 479-483, 16-20 May 1999; W. Rhee and J. M. Cioffi, Increase in capacity of multiuser OFDM system using dynamic subchannel allocation, Vehicular Technology Conference Proceedings, 2000, VTC 2000-Spring Tokyo, 2000 IEEE 51^{st}, pages 1085-1089, 15-18 May 2000; M. Ergen, S. Coleri, and P. Varaiya, QoS Aware Adaptive Resource Allocation Techniques for Fair Scheduling in OFDMA Based Broadband Wireless Access Systems, IEEE Transactions on Broadcasting, pages 362-370, December 2003; Z. Shen, J. G. Andrews, and B. L. Evans, Adaptive resource allocation in multiuser OFDM systems with proportional rate constraints, Wireless Communications, IEEE Transactions on, pages 2726-2737, November 2005; H. Kim, Y Han, and S. Kim, Joint subcarrier and power allocation in unlink OFDMA systems, IEEE Communication Letters, pages 526-528, June 2005; G. Song and G. Li, Utility-Based Resource Allocation and Schedulinci in OFDM-Based Wireless Broadband Networks, IEEE Communications Magazine, December 2005. Papers [5] and [7] propose subcarrier and bit allocation algorithms that satisfy rate requirements of users with minimum total power. Papers [6] and [9] address maximizing total throughput subject to power and subcarrier constraints. Above works consider maximizing total capacity for data traffic but do not address fairness for data traffic or QoS for real time traffic. The authors in [8], [10], [11], and [12] studied proportional fair scheduling. However these schemes also do not guarantee any short or long term transmission rates. The scheduling rules do not apply sufficiently to different QoS requirements and heterogeneous traffic.

Paper [11] by C. Zhu and J. Agre, entitled Proportional-Fair Scheduling Algorithms for OFDMA-based Wireless Systems, Preprint, Fujitsu Labs, 2006, is described in co-pending US patent application having attorney docket no. 1634.1021 and incorporated herein by reference. Paper [11] discusses a downlink resource allocation algorithm that satisfies proportional fairness for data users. Paper [11] involves a method to achieve proportional fairness among the data users by dynamically adjusting the bandwidth and transmission power assigned to these users. Paper [12] T. Girici, C. Zhu, J. Agre, and A. Ephremides, Proportional Fair Scheduling Algorithm in OFDMA-based Wireless Systems with QoS Constraints, Preprint, Fujitsu Labs, 2006, is described in co-pending US patent application having attorney docket no. 1623.1023 and incorporated herein by reference. Paper [12] discusses a downlink resource (bandwidth and transmission power) that satisfies long term proportional fairness for data users and QoS for real-time users. Paper [12] also describes a method of resource quantization so the system defined channel-bandwidth and modulation-and-coding scheme can be used. However, paper [12] could involve extensive calculation and could have a high computation overhead.

In OFDMA, a wideband channel, typically a single wideband channel, is divided into a number of narrow-band carriers referred to as sub-carriers, and these sub-carriers are allocated to users. Typically the sub-carriers that are close in the frequency spectrum have correlated channel conditions. In order to make the allocation easier sub-carriers are grouped into one or more sub-channels. There are various ways of subchannelization, e.g. contiguous grouping (i.e. Band AMC), where adjacent carriers are grouped into a single subchannel. By this method it is safe to assume that each subchannel is subject to independent and identically distributed fading. This method fully takes the advantage of OFDMA by frequency selectivity. Another method is the distributed grouping (i.e. Partial Usage of Subcarrier (PUSC)/Full Usage of Subcarrier (FUSC)) where a subchannel is formed by sampling sub-carriers across the whole range of subcarriers according to a permutation, or randomly, so that each subchannel has the same average fading with respect to a user. Most of the previous works have considered the first method in their models; however it has two main disadvantages for mobile networks. First, the proposed algorithms become too complex when each subchannel has different fading. Second, for a mobile channel with fast fading, channel estimation and feedback is more difficult than using distributed grouping.

### SUMMARY

According to an aspect of an embodiment, a practical and efficient resource allocation algorithm (method) is provided for OFDMA based wireless systems supporting heterogeneous traffic by allocating the rates to users subject to power/bandwidth constraints, according to a user selection metric and rate allocation based on traffic requirements and channel conditions. Thus, a proportional fair rate allocation with minimum rate constraint to data traffic sessions and short term rate guarantees to real-time traffic sessions is provided.

According to another aspect of an embodiment, an efficient resource allocation algorithm (method) is provided for OFDMA based wireless systems supporting heterogeneous traffic by providing proportional fairness to data users and short term rate guarantees to real-time users. First, based on the QoS requirements, buffer occupancy and channel conditions, a scheme is provided for rate requirement determination for delay constrained sessions. Then, second, the proportional fair rate allocation problem is formulated and solved subject to those rate requirements and power/bandwidth constraints. Simulation results show that the algorithm provides significant improvement with respect to the benchmark algorithm.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 is a diagram of a topology of a mobile device wireless communication cell, according to an embodiment.

FIG. 2 is a flowchart of allocating wireless communication resources in an OFDM-based wireless system, according to an embodiment.

FIG. 3 is a graph plotting the 95^{th} percentile delay at the Base Station (BS) of voice sessions vs. increasing number of voice users, according to an embodiment of the invention.

FIG. 4 is a graph plotting the total throughput at the BS vs. increasing number of voice users, according to an embodiment of the invention.

FIG. 5 is a graph plotting the 95^{th} percentile delays at the BS of video sessions vs. increasing number of video users, according to an embodiment of the invention.

FIG. 6 is a graph plotting the total throughput at the BS vs. increasing number of video users, according to an embodiment of the invention.

FIG. 7 is a graph plotting the 95^{th} percentile delay at the BS for video and voice sessions vs. increasing number of data sessions, according to an embodiment of the invention.

FIG. 8 is a graph plotting the total throughput at the BS vs. increasing number of FTP users, according to an embodiment of the invention.

FIG. 9 is a graph plotting the evolution of rate levels along with queue sizes at the BS for video users at distances 300, 900 and 1500 meters, according to an embodiment of the invention.

FIG. 10 is a graph plotting the comparison of delay and throughput at the BS for the DRA and LWDF schemes, according to an embodiment of the invention.

FIG. 11 is a diagram of an apparatus embodying the invention.

FIG. 12 is a functional diagram of processing layers (software and/or computing hardware) in the apparatus of FIG. 11, according to an embodiment.

### DETAILED DESCRIPTION OF THE PREFERRED EMBODIMENTS

### I. Introduction

The embodiments use a permutational method for subchannelization, such as PUSC and/or FUSC. Therefore, the embodiments determine how many subchannels to allocate instead of which subchannels, which makes the resource allocation more practical than using a subchannelization method of contiguous grouping, because the need to track the channel quality of each individual subchannel is eliminated. Further, the algorithms can become too complex when each subchannel has different fading in contiguous grouping, and for a mobile channel with fast fading, channel estimation and feedback is more difficult with contiguous grouping, for example, because for contiguous grouping optimization requires non-convex optimization methods like integer programming. The term resource refers to radio transmission power and/or radio bandwidth in a single channel for wireless data communication. According to an aspect of an embodiment, resources are allocated satisfying delay requirements for real time traffic, such as voice or video users, while providing proportional fair rate allocation for other traffic, such as File Transfer Protocol (FTP) users. Therefore the embodiments provide a simpler algorithm, where first a number of nodes are selected based on user selection metrics defined based on the satisfaction of short term rate constraints and then, a basic resource is allocated to users having such short term rate constraints, for example, real time traffic users, such as voice and video users, to satisfy minimum rate requirements. After that the residual resource is allocated among the selected data and video users according to any proportional fair algorithm, for example, such as the one discussed in paper [11]. In other words, in case of voice, video and other data users, an aspect of an embodiment is based upon user selection and rate requirement determination for voice and video users and solution of a proportional fair rate allocation problem subject to those rate requirements and power/bandwidth constraints for the remaining users. Although, the embodiments describe real-time data traffic as voice and/or video users, and elastic data traffic as other data users, the embodiments are not limited to such a QoS configuration, and any combinations of the data traffic can be provided and/or defined in a QoS specification based upon any application criteria. In other words, for any traffic whose QoS can be partitioned into two portions (may be empty in one portion), the first portion subject to constant throughput and stringent delay constraint, and the second portion not subject to a minimum constant throughput constraint while having variable throughput, can be treated in the same way by this invention.

### II. System Model

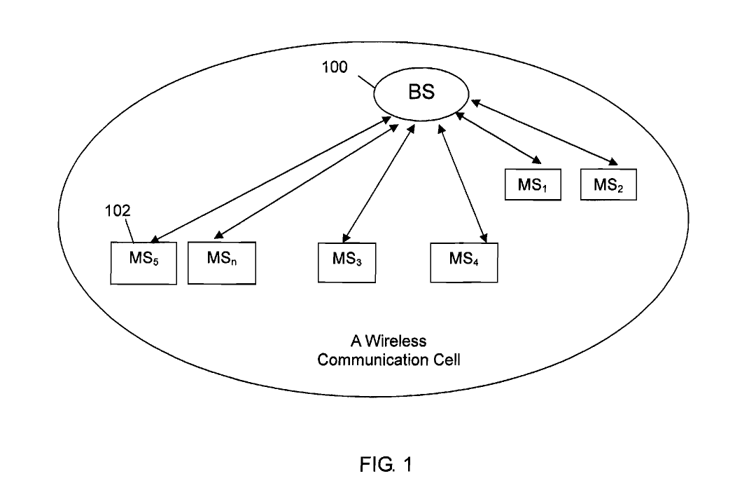

FIG. 1 is a diagram of a topology of a mobile device wireless communication cell, according to an embodiment. In FIG. 1, a wireless communication cellular system includes a base station (BS) 100 transmitting to N mobile stations/users (MSs₁₋ₙ) 102₁₋ₙ. Time is slotted and at each time slot the base station 100 allocates the total bandwidth W and total power P among the users. The users can be either fixed in location or mobile. In the simulations the users are kept fixed, however mobility can be simulated by fast and slow fading. Fast fading is Rayleigh distributed and slow fading is log-normal distributed. Total channel gain is the product of distance attenuation, fast and slow fading. Let hᵢ(t) be the channel gain of user i at time t. For an Additive White Gaussian Noise (AWGN) channel with noise p.s.d. (in other words, assuming the noise power density) N₀, the signal to interference plus noise ratio (SINR) is according to equation (1)

$${SINR}_{i} = \frac{{p}_{i} ( t ) {h}_{i} ( t )}{{N}_{0} {w}_{i} ( t )} \qquad ( 1 )$$

In Equation (1), pᵢ(t) and wᵢ(t) are the power and bandwidth allocated to user i at time t. The BS uses a set of modulation and coding (coding rate and repetitions) corresponding to certain SINR thresholds. An example of the different coding and modulation scheme and their required SINR is defined by IEEE802.16 OFDMA standard in Table I, see paper [2].

TABLE I
Example of modulation and coding schemes corresponding
to SNR values defined by 802.16e standard

| Mod/Coding | Repetition | Rate(bps/Hz) | SNR(dB) |
|---|---|---|---|
| Quadrature Phase- | 6× | ⅙ | −2.78 |
| Shift Keying (QPSK), | | | |
| ½ | | | |
| QPSK, ½ | 4× | ¼ | −1.0 |
| QPSK, ½ | 2× | ½ | 2.0 |
| QPSK, ½ | 1× | 1 | 5 |
| QPSK, ¾ | 1× | 1.5 | 6 |
| 16 Quadrature | 1× | 2 | 10.5 |
| Amplitude Modulation | | | |
| (QAM), ½ | | | |
| 16QAM, ¾ | 1× | 3 | 14 |
| 64QAM, ⅔ | 1× | 4 | 18 |
| 64QAM, ¾ | 1× | 4.5 | 20 |

In order to allocate resources, namely power and/or bandwidth, in a fair manner a constrained optimization problem is solved. In that formulation, the following rate function in Equation (2) can be used.

$${r}_{i} ( {p}_{i} ( t ) , {w}_{i} ( t ) ) = {w}_{1} ( t ) log ( 1 + \frac{β {p}_{i} ( t ) {w}_{i} ( t )}{{N}_{0} {w}_{i} ( t )} ) \qquad ( 2 )$$

The rate function equation (2) approximates the channel capacity with the Shannon capacity expression with an SINR offset factor β. The SINR offset factor can be determined by comparing the link level simulation results with the ideal Shannon channel capacity. In other words, the SINR offset factor can be determined by plotting the transmission rate vs. SINR relation both according to Table 1 and according to the relation log₂(1+βSINR) for a number of β values. The β value that makes both graphs coincide can be chosen as the right SINR factor. An example SINR offset factor based upon simulation can be β=0.25, which approximates the values in Table I quite well in different type of fading channels, for example, line of sight and/or non-line of sight types of channels. Table I is determined according to a certain bit error ratio (BER) requirement, and if the required BER is lower, the SINR thresholds in Table I become higher. Then the right β factor should become smaller, for example, β=0.1. After allocating the power and bandwidth, the SINR is quantized to the ones in the Table I. Bandwidth also is quantized to multiples of subchannel bandwidth, W_{subchannel}

The network can support different traffic types, such as (without limitation), non-elastic or Constant Bit Rate (CBR) traffic with strict delay constraints, for example, real time (VoIP). Quasi real-time traffic can be video streaming, which is bursty real-time traffic with minimum rate requirement and some delay constraints, or data applications with some rate requirements and some delay constraints, such as File Transfer Protocol (FTP). Best Effort (BE) traffic: non real-time traffic with no minimum rate requirement, for example, Internet/Web site traffic. Non-elastic and quasi-elastic data traffic can be referred to jointly or individually as real-time traffic since they both require a minimum or some rate requirement, and elastic traffic can be referred to as non real-time traffic. Simulation analysis demonstrated the effectiveness of the invention under various types of traffic scenarios. Some of the traffic conditions used in the simulations are described. Assuming that each user demands a single type of traffic for a timeslot, the following traffic types are some that can be considered in the simulation models:

1) FTP: FTP traffic has a sequence of file transmissions separated by random reading times. File sizes might be on the order of megabytes or more. As an approximation, a full buffer assumption can be considered, that is, there will always be unlimited number of packets to transmit throughout the simulation. FTP traffic can be regarded as Quasi real-time with some rate requirement and some delay constraints, or as non real time traffic.

2) Video Streaming: A video session has video frames arriving at regular intervals. There are a fixed number of packets (slices) at each frame. Each packet in a frame has a random number of bytes. Video traffic has a minimum rate requirement with certain or some delay constraints. As long as this minimum rate requirement is satisfied, the excess traffic can be treated equally as FTP and Web traffic.

3) VoIP: A VoIP session has a stream of packet arrivals with deterministic interarrival time and fixed packet lengths. Total traffic load for a VoIP session is typically much less than FTP or Video Streaming, however the stream of packets have to be delivered on time, requiring a minimum rate requirement and strict delay constraints. Packets that can't be delivered on time are considered dropped.

According to an aspect of an embodiment, the traffic can be classified into two groups of first and second classified user, with first classified users including non-elastic and/or quasi-elastic traffic, and second classified user including quasi-elastic and/or elastic users. BE traffic is elastic, that is, a BE user can use any available traffic. Throughput for individual user and fairness among different users are the performance objectives for BE traffic. Proportional fairness provides good balances between the two. Voice traffic is non-elastic; it is CBR traffic with strict delay requirements. If a voice user can receive its short term required rate level, it doesn't need excessive resources. On the other hand quasi-elastic traffic, such as Video streaming traffic is in between the two types. It has a basic rate requirement with certain delay constraints; however it is possible to achieve higher quality video transmission if the user experiences good channel conditions. An aspect of an embodiment aims to satisfy the basic rate requirement for voice and video users, while treating excessive rate requirement for video users similarly as BE data users. Typical rates for these traffic types are listed in Table III.

According to an aspect of an embodiment, the scheduling algorithm comprises user selection and rate allocation. For example, after selecting the users, the subchannels and power is allocated, although the embodiment are not limited to such a sequence of operations.

A. Modified Largest Delay First—Proportional Fairness (M-LWDF-PF)

M-LWDF-PF is described as a benchmark algorithm for performance comparison against the embodiments. In single channel systems, such as TDMA, Largest Weighted Delay First (LWDF) is shown to be throughput optimal—see paper [13] by M. Andrews, K. Kumaran, K. Ramanan, A. Stolyar, and P. Whiting, Providing Quality of Service over a Shared Wireless Link, IEEE Communications Magazine, pages 150-154, February 2001. In this scheme at each time slot the user maximizing the following quantity transmits.

aᵢD_{HOL}i(t)rᵢ(P,W) (3)

where D_{HOLi} (t) is the head of line packet delay and rᵢ(P,W) is the channel capacity of user i at frame t (calculated from (2), where P and W is the fixed transmission power and channel bandwidth). The parameter a, is a positive constant. If QoS is defined as

P(Di>D^{max}i)<δi, (4)

where D^{max}i is the delay constraint and δᵢ is the probability of exceeding this constraint (typically 0.05), then the constant aᵢ can be defined as aᵢ=−log(δi) D^{max}ᵢRi(t), which is referred to as M-LWDF-PF as discussed in papers [10], [13]. Here, Rᵢ(t) is the average received rate (i.e., transmission rate the user has been served in previous time slot(s) or a previous transmission rate of the user). Averaged (filtered) values of long term received rates of users, which is computed as follows:

Ri(t+1)=αᵢRi(t)+(1−αᵢ)ri(pi(t),wi(t)) (5)

The equation above can be considered as a filter with time constant 1/(1−αᵢ) for user i. The constant αᵢ should be chosen such that the average received rate is detected earlier than the delay constraint in terms of frame durations. 100 msec, 400 msec and 1000 msec as the delay constraints of voice, streaming and BE users can be chosen. Converting these values into number of frames of 1 msec, provides the a values in Table III. M-LWDF-PF can be adapted to OFDMA systems as follows. Power is distributed equally to all subchannels. Starting from the first subchannel, the subchannel is allocated to the user maximizing (3). Then the received rate R(t) is updated according to (5). All the subchannels are allocated one-by-one according to this rule. This algorithm is used as the benchmark in the simulations discussed herein.

B. According to an aspect of an embodiment a Delay and Rate Based Resource Allocation (DRA) is provided:

There are two main disadvantages of the M-LWDF-PF algorithm. First, there is no power allocation in this scheme, i.e., the same transmission power is used in all the subchannels. Performance can be increased by dynamic power allocation in the subchannels, however, DRA increases performance by using dynamic bandwidth allocation for non-elastic data traffic and for elastic data traffic dynamic bandwidth allocation joint with dynamic power allocation. Secondly, other types of data users are much different than video and voice in terms of QoS requirements. Therefore it is hard to use the same metric for elastic, quasi-elastic, and non-elastic data traffic of users as done in LWDF and discussed in pager [13]. According to another aspect of the invention, DRA increases performance by joint guarantee of minimum rate requirements of quasi and/or non-elastic data traffic users and optimization of proportional fairness of elastic data traffic users. The embodiments are not limited to these classified data traffic types and other data traffic type classifications or any combinations thereof can be determined according to application criteria.

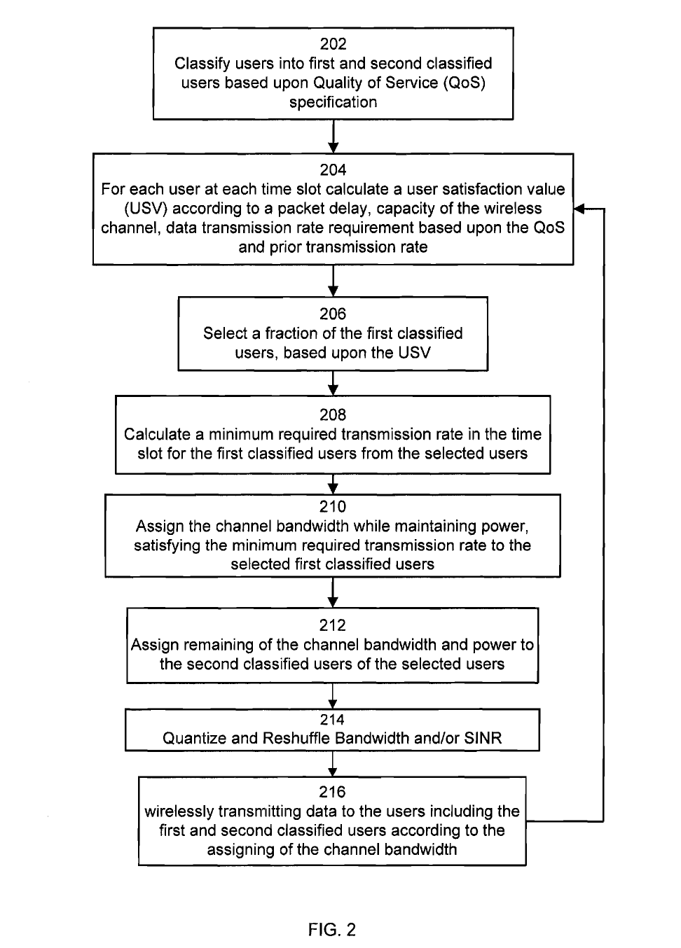

FIG. 2 is a flowchart of allocating wireless communication resources in an OFDM-based wireless system, according to an embodiment. At 202, users are classified into first and second classified users based upon a Quality of Service (QoS) specification. According to an aspect of an embodiment, the QoS specification specifies elastic data traffic type without a minimum transmission rate requirement, quasi-elastic data traffic type with a minimum rate requirement and some delay constraints, and non-elastic data traffic type with a minimum rate requirement and a strict delay constraint. The first classified users require non-elastic and/or quasi-elastic data traffic type and the second classified users require quasi-elastic and/or elastic data traffic type. For example, the non-elastic data traffic is voice data, quasi-elastic data traffic is one or more of video streaming or File Transfer Protocol (FTP) data, and elastic data traffic is Web site data. At 204, the users to be served in the current time frame are chosen according to the following User Satisfaction Value (USV).

$$U S {V}_{i} ( t ) = {L}_{i} {D}_{i}^{HOL} log ( 1 + \frac{β {p}_{i} ( t ) {h}_{i} ( t )}{{N}_{0} {w}_{i} ( t )} ) \frac{{r}_{i}^{0}}{{R}_{i} ( t )} \qquad ( 6 A )$$

Here Li=−log(δi) ID^{max}ᵢ and r⁰ᵢ is the basic rate requirement for user i. Let U_{D}, U_{S} and U_{V} be the BE, Video and Voice users. Let U_{R}=U_{S}∪U_{V} be the set of real time users. Let U_{E} and Ū_{E}, be the set of users demanding elastic traffic and the rest, respectively. More particularly, at 204, for each user at each time slot a user satisfaction value (USV) is calculated according to a delay in time of current head-of-line packet (next packet to be transmitted) in the transmission queue (Dᵢ^{HOL}), capacity of the wireless channel, data transmission rate requirement based upon the QoS (rᵢ⁰) and prior transmission rate (Rᵢ(t)). This metric jointly captures considerations of delay, bandwidth efficiency and rate requirement satisfaction. For real time users all of these parameters have to be included in this metric in order to optimize performance. The embodiment would still operate in the absence of some of the components in the metric, although with degraded performance. For data users the first component for delay becomes unnecessary, because these users don't have a delay constraint. In other words, where a user has no delay or minimal throughput requirement, some nominal constant can be used instead of LᵢD^{HOL}ᵢ and/or r⁰ᵢ.

According to an aspect of an embodiment, a scheduling part is provided, wherein the base station 100 chooses a number of data and real time users to transmit. Further, the quantity or fraction of users chosen from data and real time users is also an important parameter. Choosing too many real time users gives excessive resources to those users and can leave little or no resources for the data users. Choosing too many data users is both bad for real time users and it may also decrease the achievable rate. At 206, a fraction of the first classified users is selected based upon the USV (6A). Namely, at 206, Equation (7) determines the fraction F_{R}(t) of non-elastic and quasi real time users scheduled in each time slot,

$${F}_{R} ( t ) = \frac{1}{\vert {U}_{R} \vert} {\sum }_{i ∈ {U}_{R}} I ( {q}_{i} ( t ) > {C}_{1} {D}_{i}^{max} {r}_{i}^{0} ) \qquad ( 7 )$$

Here qᵢ(t) is the queue size in bits and C₁ D^{max}ᵢr⁰ᵢ denotes a queue size threshold in bits and l(.) is the indicator function taking value one if the argument inside is true. As more users exceed this threshold, more fractions of real time users are scheduled. C₁ is the coefficient of queue size threshold, and in simulations approximately 0.5 (50% or halfway or about 45%-55% or approaching 50%) can be reasonable. However, the embodiments are not limited to 50% as the queue size threshold, and any queue size threshold range can be provided depending upon one or more of system performance (e.g., processing speed, failure, etc.), QoS, etc. for maintaining serviceable buffer occupancy without exceeding buffers. For data (i.e., elastic) users, the BS 100 simply chooses approximately a fraction of 0.2 (20%) of elastic users. In simulations, approximately 20% of elastic users yielded a good balance between supporting the non-elastic and/or quasi users vs. elastic users.

An example benefit of the embodiments of the invention is if it is decided to transmit all the real time queues with nonzero occupancy at each time slot, then data performance significantly worsens, because there might only be, for example, 30 subchannels and most of them are occupied by real time users. In the other extreme, if only one real time user is transmitted each time, then especially voice users are badly affected because, their delay constraint is more strict. Using the USV explained in (6A) along with the user fraction formula in (7) provides a good compromise between two extremes. It determines just enough number of real time users at each scheduling instant, so that all of the real time users that have good channel conditions and buffer occupancies above a certain threshold are selected. Using (6A) and (7) also prevents transmission of excessive number of real time users and maintains bandwidth efficiency by scheduling data users with good channel conditions. In other words, the way the USV is calculated provides a balance between the different QOS requirements.

According to another aspect of an embodiment, the USV and the fraction (quantity) of users selected at each time slot can be determined as follows:

$$U S {V}_{i} ( t ) = \{ \begin{matrix}{L}_{i} {D}_{i}^{HOL} log ( 1 + \frac{β {p}_{i} ( t ) {h}_{i} ( t )}{{N}_{0} {w}_{i} ( t )} ) \frac{{r}_{i}^{0}}{{R}_{i} ( t )} {R}_{i} ( t ) > {r}_{i}^{0} {C}_{2} \\ {L}_{i} {D}_{i}^{HOL} log ( 1 + \frac{β {p}_{i} ( t ) {h}_{i} ( t )}{{N}_{0} {w}_{i} ( t )} ) {( \frac{{r}_{i}^{0}}{{R}_{i} ( t )} )}^{2} {R}_{i} ( t ) \leq {r}_{i}^{0} {C}_{2}\end{matrix} \qquad ( 6 B )$$

The USV in equation (6B) is a piecewise function that increases faster when received rate (i.e., transmission rate the user has been served in previous time slot(s) or a previous transmission rate of the user) falls below a coefficient of the required rate C₂. For example, in simulations a fraction (0.7) of required rate was determined to be reasonable. Another example is to set this threshold to 1. This coefficient can be found by trial and error.

According to another aspect of an embodiment, the fraction of users to be transmitted can also be chosen as follows: the real time (streaming, voice) users and data users are placed in separate pools. Let D, S and V be the number of data, streaming and voice users. From the

real time users a fraction

$$\frac{4 + ( 0.1 D + 0.1 S + 0.05 V )}{D + S + V}$$

of them are chosen. As seen from this expression, the number of chosen real time users increases linearly with the number of them. It also decreases with increasing number of data users. From the data users a fraction

$$\frac{2 + 0.1 D}{D}$$

of them are chosen. In other words, at each time slot a fraction of

$$\frac{4 + ( 0.1 D + 0.1 S + 0.05 V )}{D + S + V}$$

of real time users and a fraction of

$$\frac{2 + 0.1 D}{D}$$

of data users are selected. These coefficients can be found by trial and error, and in terms of performance these coefficients are found to be good with respect to choosing too many or too few real time users. Next, the joint power and bandwidth allocation that is performed on these chosen users at each time slot is described.

### IV. Joint Power and Bandwidth Allocation

After the users are chosen, joint power and bandwidth allocation is performed. Let UD′, US′ and UV′ be the chosen users that belong to all three traffic classes. The algorithm is as follows:

A. Basic Rate Allocation for Real Time Users

At 208 a minimum required transmission rate in the time slot for the first classified users from the selected users is calculated. In particular, for the selected real time users (iεU_{R}′) the rate requirements are determined first. Rate requirement for real time user i is,

$${r}_{i}^{c} ( {q}_{i} ( t ) , {ω}_{i} ( t ) ) = min ( \frac{{q}_{i} ( t )}{{T}_{s}} , \frac{{r}_{i}^{0}}{{ω}_{i} ( t )} ) , i ∈ {U}_{R}^{′} , \qquad ( 8 )$$

Here qᵢ(t) is the queue size and ωᵢ(t) is the transmission frequency of user i, which is updated as follows:

ωᵢ(t)=αᵢωᵢ(t−1)+(1−αᵢ)I(rᵢ(t)>0), (9)

where l(rᵢ(t)>0) is the function that takes value one if the node receives packets in time slot t, zero otherwise. Therefore this frequency decreases if the node transmits less and less frequently. Using this frequency expression in the basic rate function compensates for the lack of transmission in the previous time slots possibly due to bad channel conditions. For the chosen real time users with non-elastic traffic (iεŪ_{E}∩U_{R′}) the basic resource allocation is enough to support the session. For these users the basic resource is allocated as follows, and these user are not included in the additional rate allocation which will be defined later. First, the nominal SINR γ⁰ᵢ is determined based upon the assumption that equal power is applied across all the subchannels. For, example, the first, the nominal SINR γ⁰ᵢ is determined according to the uniform power per bandwidth allocation as γ⁰ᵢ=Phi(t)/N₀W. The γ⁰ᵢ is quantized to the closet SINR level defined in Section II. For example, then γ⁰ᵢ is quantized by decreasing Phᵢ(t)/N₀W to the closest SINR level defined in Section II. If γ⁰ᵢ is smaller than the smallest SNR level, then the ceiling is taken. Based on this nominal SINR, nominal bandwidth efficiency S⁰ᵢ(t) (in bps/Hz) is determined based on the modulation and coding scheme supported by γ⁰ᵢ (i.e., using the values in Table I). Using this basic rate and the nominal bandwidth efficiency, basic bandwidth for non-elastic traffic is determined as w^{min}ᵢ=r^{min}ᵢ)/S⁰ᵢ(t), iεŪ_{E}∩UR′. Then this bandwidth is quantized to a multiple of subchannel bandwidth by w^{min}ᵢ=max(1,└w^{min}ᵢ┘j)W_{subchannel}. Minimal power for this user is then p^{min}ᵢ=γ⁰ᵢw^{min}ᵢN₀hi(t), ∀iεŪ_{E}∩UR′. Hence pᵢ=p^{min}ᵢ and wᵢ=w^{min}ᵢ for these users. In other words, at 210, the channel bandwidth is assigned satisfying the minimum required transmission rate to the selected first classified user, while assuming power is divided equally across all the subchannels.

After the basic allocation, if the total bandwidth or power is greater then the available resource, the user with the largest power is chosen, bandwidth is decreased by one subchannel and the power is also decreased in order to keep the SINR fixed. This process is continued until the total bandwidth and power for voice and video users becomes smaller than the available resources

B. Proportional Fair Resource Allocation for Data and Video Streaming

At 212, the remaining of the channel bandwidth is assigned to the second classified users of the selected users. Namely, let the residual power and bandwidth after non-elastic real time traffic allocations be P′=Σ_{iεŪE′∩U}_{_{R}}, pᵢ^{min} and W′=ΣiεŪE′∩U_{_{R}}, wᵢ^{min}. For real time users with elastic traffic (iεU_{R}′∩U_{E}), the basic rate is included as a constraint in joint residual bandwidth-power allocation, which will be explained next. At this stage the residual power (P′) and bandwidth (W′) is allocated among the chosen users demanding elastic data traffic and quasi-elastic real time traffic in a proportional fair manner. The Proportional Fair (PF) resource allocation problem as defined in Equation (10) is solved among the chosen streaming and data users by finding ( p̅, w̅) that maximizes:

$${max}_{\overline{p} , \overline{w}} {\prod }_{i ∈ {U}_{E} ⋂ ( {U}_{R}^{′} ⋃ {U}_{D}^{′} )} {( {w}_{i} log ( 1 + \frac{{p}_{i}}{{n}_{i} {w}_{i}} ) )}^{φ i} \qquad ( 10 )$$

subject to,

$$\begin{matrix}{w}_{i} log ( 1 + \frac{{p}_{i}}{{n}_{i} {w}_{i}} ) \geq {r}_{i}^{min} , ∀ i ∈ {U}_{E} ⋂ {U}_{R}^{′} & ( 11 ) \\ {\sum }_{i ∈ {U}_{E} ⋂ ( {U}_{R}^{′} ⋃ {U}_{D}^{′} )} {p}_{i} \leq {P}^{′} & ( 12 ) \\ {\sum }_{i ∈ {U}_{E} ⋂ ( {U}_{R}^{′} ⋃ {U}_{D}^{′} )} {w}_{i} \leq {W}^{′} & ( 13 ) \\ {p}_{i} , {w}_{i} \geq 0 , ∀ i ∈ {U}_{E} ⋂ ( {U}_{R}^{′} ⋃ {U}_{D}^{′} ) & ( 14 )\end{matrix}$$

Here log-sum is written as a product. The above problem is a convex optimization problem with a concave objective function and convex set—see paper [14] by L. Vanderberghe S. Boyd. Convex Optimization. Mar. 8, 2004. The solution of the present invention to the optimization problem differs from paper [12], because in paper [12] both elastic data traffic and quasi-elastic real time traffic users are optimized together (concurrently) in the log-sum. According to an aspect of the embodiments, operations that meet the QoS requirements of different users involve a user selection metric and rate allocation based on traffic requirements and channel conditions. The operation of maximizing the proportional fairness among elastic and quasi-elastic traffic users can be similar to the approach used in paper [11]. Optimization in Equation 10 also includes the parameter φᵢ, which depends on the traffic type. Since data users typically can take advantage of higher rates and video users are already allocated the basic bandwidth, higher φi may be given for data users. This problem can be solved using the Lagrange multipliers.

C. Bandwidth and/or SINR Quantization and/or Reshuffling, and Transmission

At 214, the bandwidth and/or SINR are quantized and/or reshuffled. At 216, the BS 100 wireless transmits data to the users including the first and second classified users according to the assigning of the channel bandwidth. For example, at 214, after the resources are allocated, first the bandwidth for data and video streaming users is quantized as wᵢ=max(1, └Wᵢ┘)W_{subchannel}. Then the SINR is quantized to get the closest value in, for example Table I, and transmit power is determined to reach that SINR. Unlike best effort transmission, queue size plays an important role in real time transmissions. As a result of the above optimization some streaming time users may get more rates than that is enough to transmit all bits in the queue. Some of the bandwidth is taken from video users in order to obey this queue constraint. After these modifications, if the total bandwidth is greater than the available, then the user with the highest power is found and its bandwidth decreased. Power is recalculated in order to keep the SINR fixed. This process is continued until the bandwidth constraint is satisfied. If total power is still greater than the available, then again choosing the user with highest power and decreasing bandwidth until the power constraint is satisfied. If after these processes there is a leftover bandwidth, a subchannel is added to the user that has the highest channel and power is increased accordingly (if there is enough power to do so). If there is some leftover power, then starting from the user with lower channel gains, SINR is boosted to the next power level (if there is enough power to do so). For the real time users we don't increase bandwidth or power if there isn't enough buffer content.

V. Numerical Evaluation

For the numerical evaluations, the users can be divided into classes according to distances from the BS 100, for example, into 5 classes according to the distances, 0.3, 0.6, 0.9, 1.2, 1.5 km. For instance if there are 5 voice users in the system (i.e., cell shown in FIG. 1), at each distance class a single Voice user is located. For k×5 user there are k users for each session of the same type is located at each distance point. The parameters in Table II can be used.

TABLE II
Simulation Parameters

| Parameter | Value |
|---|---|
| Cell radius | 1.5 km |
| User Distances | 0.3, 0.6, 0.9, 1.2, 1.5 km |
| Total power (P) | 20 W |
| Total bandwidth (W) | 10 MHz |
| Frame Length | 1 rasa |
| Voice Traffic | CBR 32 kbps |
| Video Traffic | 802.16-128 kbps |
| FTP File | 5 MB |
| AWGN p.s.d.(N₀) | −169 dBm/Hz |
| Path loss exponent (γ) | 3.5 |
| ψ_{dB} ~ N(μ_{ψdB}, σ_{ψdB}) | N(0 dB, 8 dB) |
| Coherent Time (Fast/Slow) | (5 msec/300 msec.) |
| Path loss(dB, d in meters) | −31.5-35 logᵢₒ d + ψ_{dB} |

The following equations can be used to determine the OFDMA channel parameters.

A. Physical Layer Parameters:
Nominal Channel Bandwidth: W=10 MHz
FFT size N_{FFT}: Number of samples in the fast Fourier Transformation-1024
   Number of used Subcarriers N_{used}: Outer carriers do not carry any modulation data. Typically it can be 840.
Sampling Factor: nₛ=Fₛ/W=8/7
Sampling Frequency Fₛ=floor(n×W/8000)×8000=11.424 MHz
Subcarrier spacing Δf: Fₛ/N_{FFT}=1.1156×10⁴ Hz
Used Bandwidth N_{used}×Δf=9.37125 MHz
Useful symbol Time: T_{b}=1/Δf=89.638 μs
Guards Period ratio: 1/8
OFDM Symbol time Tₛ=(1+1/8)×T_{b}=0.1008 msec.
Subchannelization mode: DL-PUSC
Tones per subchannel: 24
Subchannel bandwidth=W_{sub}=24×Δf=267.744 Khz
Number of subchannels: 30

The inventive DRA is compared with the benchmark M-LWDF algorithm with proportional fairness. Delay exceeding probability is taken as δᵢ=0.05 for all users. The traffic and resource allocation parameters are listed in Table III. Since data users are chosen separately from others, the parameters Lᵢ and head of line delay Dᵢ^{HOL} are not used for data sessions.

The measured performance metrics are 95th percentile delay for real time sessions and total throughput for data sessions. These metrics can be observed with respect to number of users for each type of sessions. For the delay, the users can be observed in the range 0.3-1.2 separately as good users and the ones at 1.5 km as bad users.

TABLE III
Minimum required and maximum sustained
rates for different types of traffic

| Traffic | r⁰(kbps) | r^{max}(kbps) | D^{max}(s) | Lᵢ | φᵢ | αᵢ |
|---|---|---|---|---|---|---|
| VoIP | 32 | 32 | 0.1 | 13 | — | 0.98 |
| Streaming | 128 | 1024 | 0.4 | 3.25 | 1 | 0.995 |
| FTP | 10 | ∞ | 2 | 0.65 | 2 | 0.998 |
| BE | 0 | ∞ | 2 | 0.65 | — | 0.998 |

B. Increasing Number of Voice Users

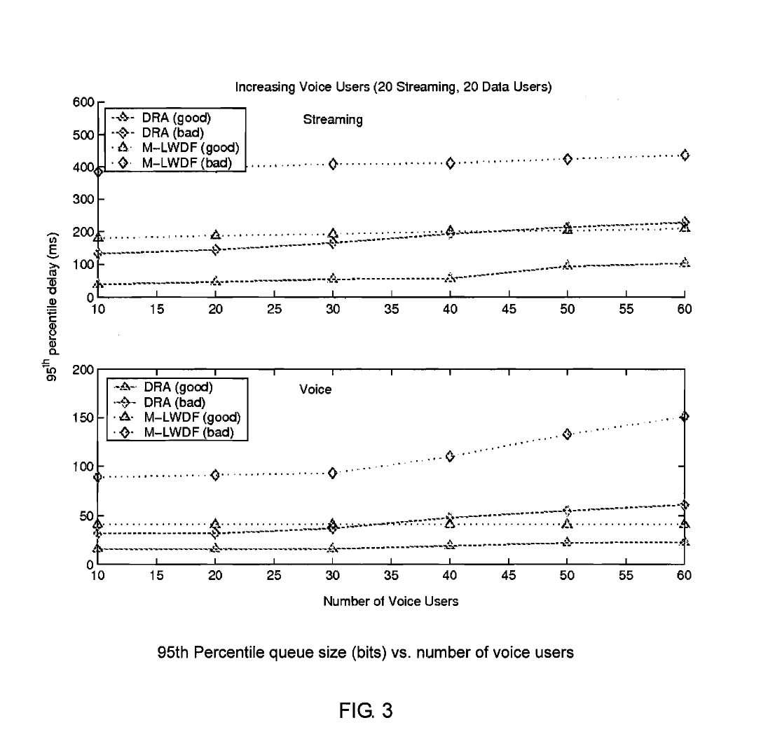

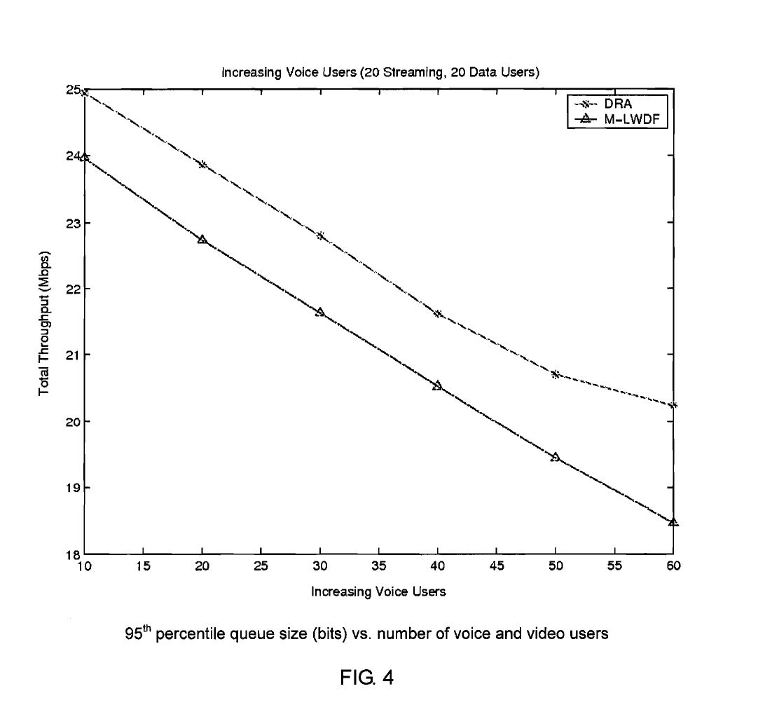

In FIG. 3 is a graph plotting the 95^{th} percentile delay at the Base Station (BS) of voice sessions vs. increasing number of voice users, according to an embodiment of the invention. For this simulation the number of data and Video users was fixed at 20 each. The graph shows there is a slight increase in delay with increasing voice sessions. Delay for bad users exceeds the threshold with the M-LWDF algorithm, while for DRA they are in the acceptable range. FIG. 4 is a graph plotting the throughput at the BS vs. increasing number of voice users, according to an embodiment of the invention. FIG. 4 shows DRA algorithm is also better in terms of total throughput. It can also be observed that total throughput decreases linearly with increasing voice sessions.

C. Increasing Number of Video Users

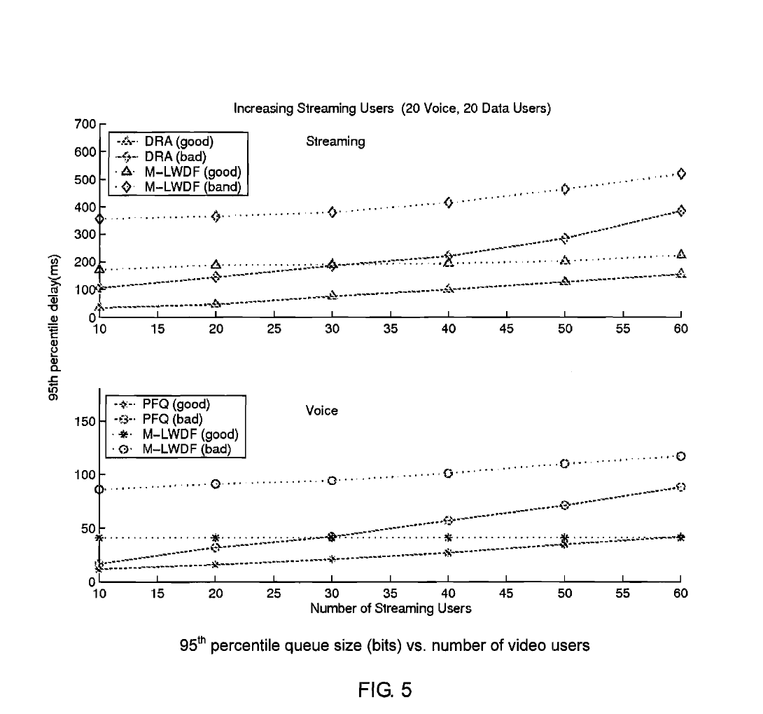

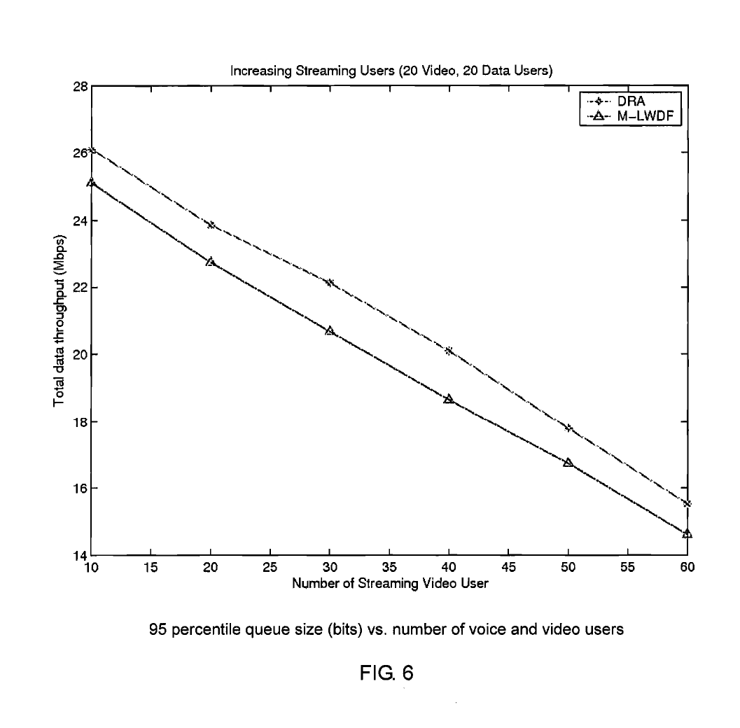

In these simulations, the video traffic rate is fixed at 128 kbps and treated as non-elastic. CBR voice traffic is considered, where a fixed length packet arrives periodically. For the Video traffic the model in IEEE 802.16e system evaluation methodology is used. Packet lengths, and inter arrival times truncated Pareto distributed such that average rate is 128 kbps (Although the packet lengths are varying, the average bit rate can be fixed throughout the simulation durations). For the BE traffic it is assumed that there are unlimited number of packets in the queue. FIG. 5 is a graph plotting the 95^{th} percentile delays at the BS of video sessions vs. increasing number of video users, according to an embodiment of the invention. In FIG. 5, the DRA can be referred to as proportional fair queuing (PFQ), because resource assignment in Equation 9 achieves proportional fair queuing. For this simulation, the number of data and Voice users was fixed at 20. Again it can be observed that 95 percentile delay for video sessions increases exponentially with number video users, while delays for the users at the edge is within the acceptable range for DRA unlike M-LWDF. FIG. 6 is a graph plotting the throughput at the BS vs. increasing number of video users, according to an embodiment of the invention. FIG. 6 shows that total data rate decreases linearly with increasing video users. Data performance of DRA is again better than M-LWDF.

D. Increasing Number of FTP Users

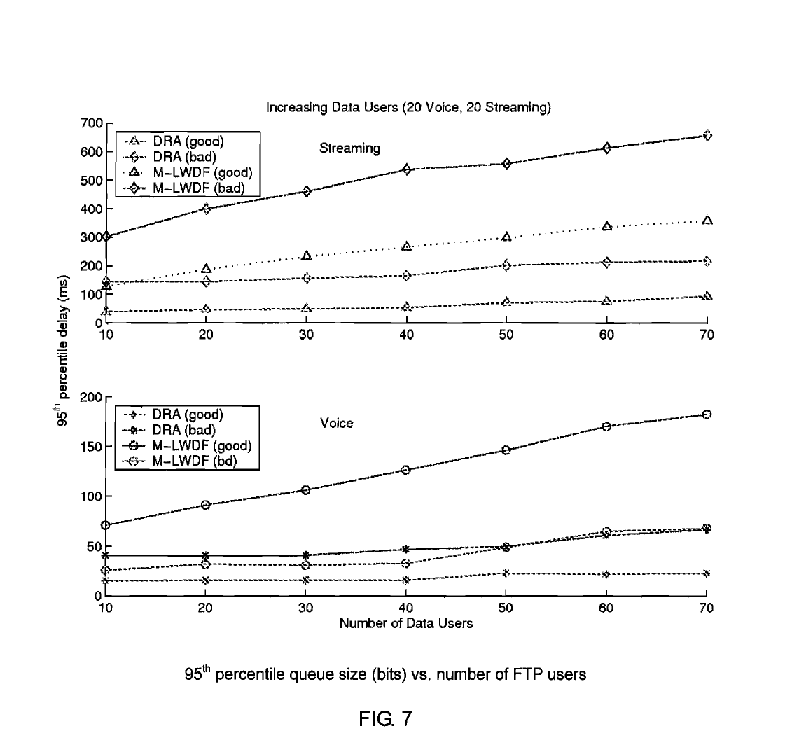

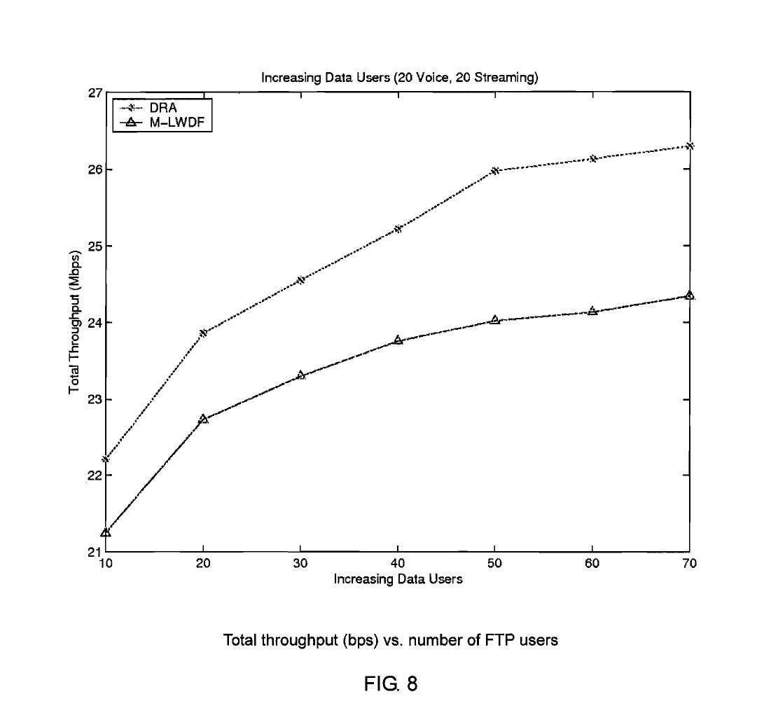

FIG. 7 is a graph plotting the 95th percentile delay at the BS for video and voice sessions vs. increasing number of data sessions, according to an embodiment of the invention. The number of Streaming and Voice sessions is kept fixed at 20. It can be observed a linear increase in the delay with respect to the number of data sessions with M-LWDF. The delay increase is negligible for DRA. FIG. 8 is a graph plotting the total throughput at the BS vs. increasing number of FTP users, according to an embodiment of the invention. FIG. 8 shows that total throughput increases as the number of FTP users increases for both algorithms. This is because of multiuser diversity. After some increase, the total throughput reaches a capacity. Capacity corresponding to DRA is approximately 10 percent higher than that of M-LWDF.

E. Video Traffic with Adaptive Average Rate

In the previous simulations average video traffic rater was fixed and therefore it was considered and treated as non-elastic real time traffic. In these simulations average rate video traffic rate can be time varying. In real systems video coding is often adaptive where video data includes a base and enhancement layers, where the number of layers transmitted can depend on channel conditions. According to an aspect of an embodiment, a rate control scheme is provided that looks at the average head of line packet delay and increases or decreases average input rate according to a threshold policy. Rate levels r⁰ᵢλᵢ, (λᵢε{1, 2, . . . , 8}) are defined which are integer multiples of 128 kbps. Inter arrival times are the same for level 1 and k, however for level k packet size is k times larger for each packet.

For each user iεU_{E}∩U_{R} and at each update instant,

if D̅ᵢ^{HOL}(t)<0.125 D^{max}ᵢ then λᵢ=min{λᵢ+1,λₘₐₓ}

if D̅ᵢ^{HOL}(t)>0.25 D^{max}ᵢ then λᵢ=max{λᵢ−1,1}
else, λᵢ=λᵢ

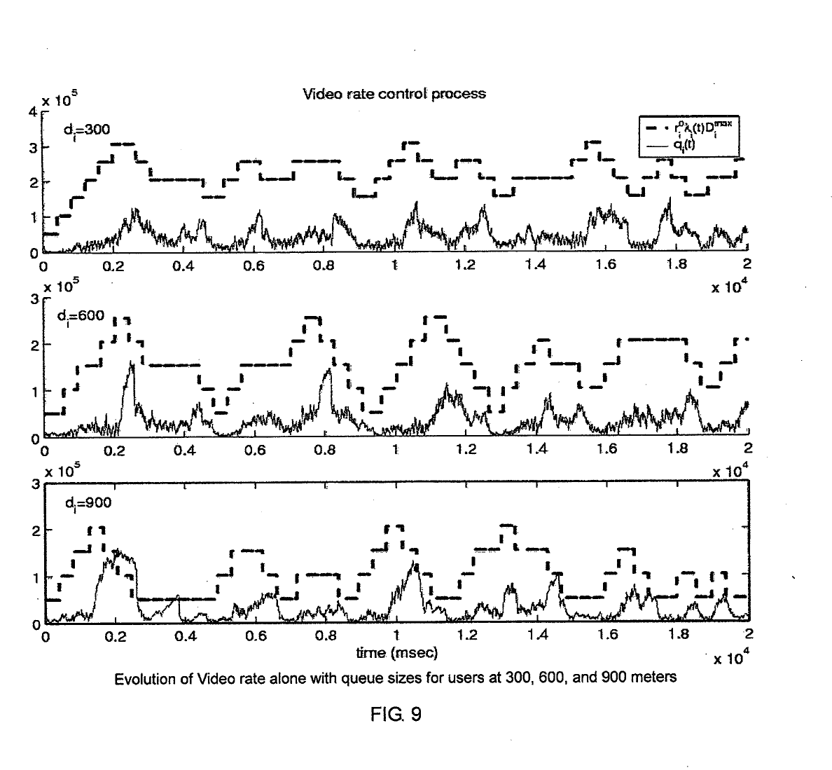

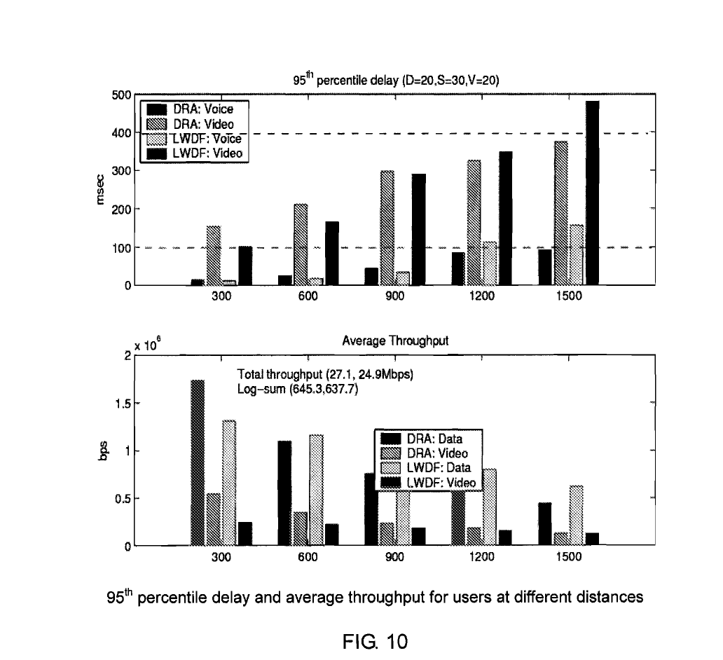

Here D̅ᵢ^{HOL}(t) denotes mean HOL packet delay in the last 400 frames. According to the updates in Equation (15), average rate is increased by one level if the average packet delay satisfies a lower average delay threshold and is decreased by one level the average packet delay violates an upper average packet delay threshold. The updates are made at each 200 frames. FIG. 9 is a graph plotting the evolution of rate levels along with queue sizes at the BS for video users at distances 300, 900 and 1500 meters, according to an embodiment of the invention. FIG. 9 shows that users closer to the BS can achieve higher rates. FIG. 10 is a graph plotting the comparison of delay and throughput at the BS for the DRA and LWDF schemes, according to an embodiment of the invention. FIG. 10 shows that DRA system satisfies delay constraints for voice users unlike LWDF. As for throughput, FIG. 10 shows that DRA can provide significantly better throughput for video users at all distances. Total data/video throughput and log-sum throughput (proportional fairness) is also better for DRA scheme.

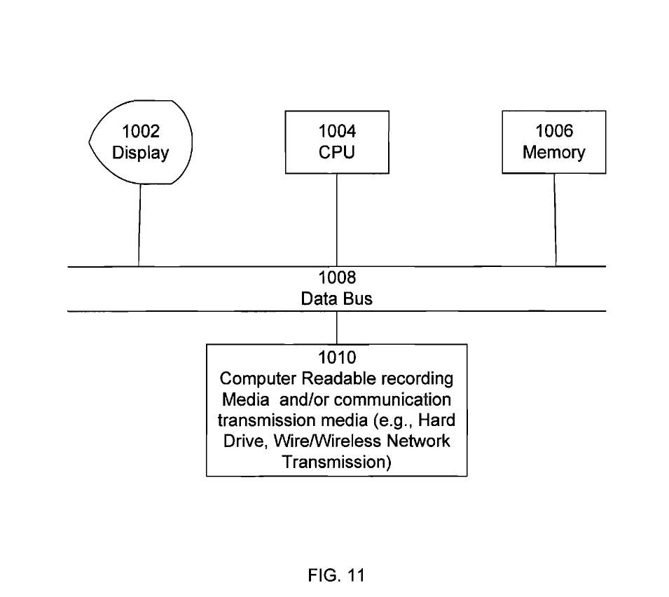

The embodiments can be implemented in computing hardware (computing apparatus) and/or software, such as (in an unlimiting example) any computer that can store, retrieve, process and/or output data and/or communicate with other computers. FIG. 11 is a diagram of an apparatus, namely any type of computer or device having a computing processor embodying the inventive embodiment operations of allocating resources for OFDMA-based wireless communication systems. According to an aspect of an embodiment, the apparatus of FIG. 11 embodies a BS. In FIG. 11, the apparatus can be any computing device, for example, a personal computer. Typically, the apparatus includes a display 1002 to display a user interface. A controller 1004 (e.g., a central processing unit) executes instructions (e.g., a computer program or software) that control the apparatus to perform operations. Typically, a memory 1006 stores the instructions for execution by the controller 1004. According to an aspect of an embodiment, the apparatus reads/processes any computer readable recording media and/or communication transmission media 1010. The display 1002, the CPU 1004, the memory 1006 and the computer readable recording media and/or communication transmission media 1010 are in communication by the data bus 1008. The result of resource allocation at the BS is used to downlink transmit data from the BS to the MS, and related information of the resource allocation can be displayed on the display 1002 of the computing device. A program/software implementing the embodiments may be recorded on computer readable media comprising computer-readable recording media. The program/software implementing the embodiments may also be transmitted over a transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. Examples of transmission communication media include a carrier-wave signal, an optical signal, etc. Further, according to an aspect of the embodiments, any combinations of the described features, functions and/or operations, including benefits thereof, can be provided and/or achieved.

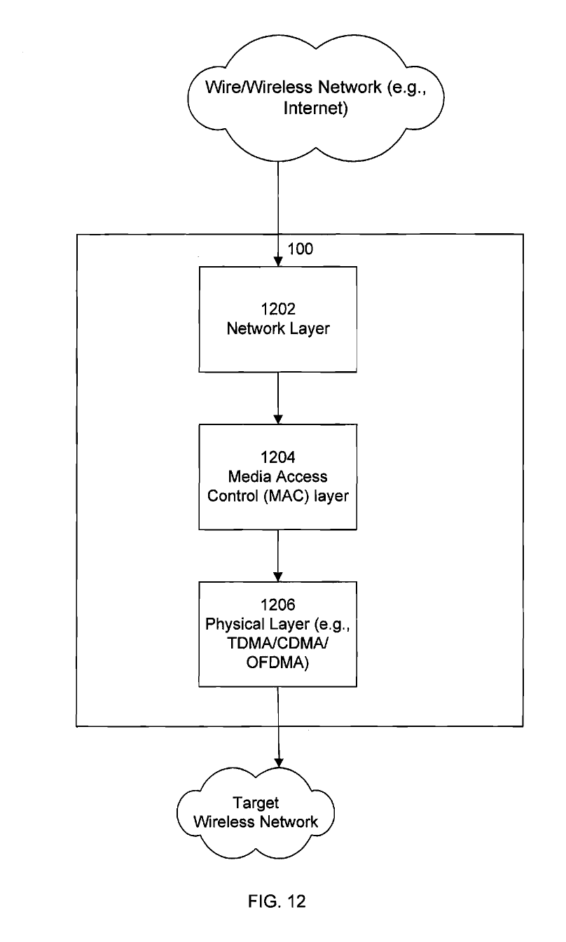

FIG. 12 is a functional diagram of processing layers (software and/or computing hardware) in the apparatus of FIG. 11, according to an embodiment. In FIG. 12, the processing layers comprise a network layer 1202, a Media Access Control (MAC) layer 1204 and a physical layer 1206. FIG. 12 processing layers are logical layers, and the embodiments are not limited to these example processing layers and other processing layer configurations may be provided. According to an aspect of an embodiment, the network layer 1202 is software executed by the controller 1004. The MAC 1204 and physical layers 1206 are software and/or computing hardware included as computer readable media in the wireless communication network unit 1010. The MAC layer 1204 and physical layer 1206 implement various target wireless network access specifications, such as (without limitation) OFDM, OFDMA, TDD, FDD and/or CDM. A target wireless network example can be the cell 100. In one embodiment, the radio resource allocation according to the embodiments is in the MAC layer 1204 and/or the physical layer 1206 specification of target wireless network nodes, for example, in a base station (BS) 102. Typically (without limitation) the network layer 1202 provides wire and/or wireless communication access to private/public network(s) (e.g., Internet) other than the target wireless network. The network layer 1202 can be used for management functions, such as dynamically (real-time) (e.g., for example, according to various criteria) provide (download) the configuration/control parameters, such as QoS specifications, for the embodiment radio resource allocation.

According to an aspect of an embodiment, a method of allocating Orthogonal Frequency-Division Multiple Access (OFDMA)-based wireless data communication resources of a wireless channel in a downlink transmission direction by a base station computing device in a wireless communication cell, comprises classifying users into first and second classified users based upon a Quality of Service (QoS) specification; for each user at each time slot selecting users according to a user satisfaction value (USV) based upon a packet delay, capacity of the wireless channel, data transmission rate requirement based upon the QoS and prior transmission rate; calculating a minimum required transmission rate in the time slot for the first classified users from the selected users; assigning the channel bandwidth while maintaining equal transmission power, satisfying the minimum required transmission rate to the selected first classified users; assigning remaining of the channel bandwidth and transmission power to the second classified users of the selected users; and wirelessly transmitting data to the users including the first and second classified users according to the assigning of the channel bandwidth. According to an aspect of an embodiment, the assignment of channel bandwidth and transmission power is in permutation based subchannels of OFDMA wideband channel.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the invention to the exact construction and operation illustrated and described, and accordingly all suitable modifications and equivalents may be resorted to, falling within the scope thereof.

What is claimed is:

1. A method of allocating Orthogonal Frequency-Division Multiple Access (OFDMA)-based wireless data communication resources of a wireless channel in a downlink transmission direction by a base station computing device in a wireless communication cell, comprising:
classifying users into first and second classified users based upon a Quality of Service (QoS) specification;
for each user at each time slot selecting users according to a user satisfaction value (USV) based upon a packet delay, capacity of the wireless channel, data transmission rate requirement based upon the QoS and prior transmission rate;
calculating a minimum required transmission rate in the time slot for the first classified users from the selected users;
assigning the channel bandwidth while maintaining equal transmission power, satisfying the minimum required transmission rate to the selected first classified users;
assigning remaining of the channel bandwidth and transmission power to the second classified users of the selected users; and
wirelessly transmitting data to the users including the first and second classified users according to the assigning of the channel bandwidth.

2. The method according to claim 1,
wherein the QoS specification specifies elastic data traffic type without a minimum transmission rate requirement, quasi-elastic data traffic type with a minimum rate requirement and some delay constraints, and non-elastic data traffic type with a minimum rate requirement and a strict delay constraint, and
wherein the first classified users require non-elastic and/or quasi-elastic data traffic type and the second classified users require quasi-elastic and/or elastic data traffic type.

3. The method according to claim 2, wherein the non-elastic data traffic is voice data, quasi-elastic data traffic is one or more of video streaming or File Transfer Protocol (FTP) data, and elastic data traffic is Web site data.

4. The method according to claim 2, wherein the user classification is dynamically changeable by the user and/or the base station.

5. The method according to claim 1, wherein the users are ranked in a descending order according to the USV, and the selection of the users comprises selecting a fraction of the users from the ranked users.

6. The method according to claim 5, wherein a quantity of the fraction of the ranked users is determined based upon users whose queue size is approaching and/or exceeding by a predetermined amount, a predetermined queue size;

7. The method according to claim 1, wherein the assignment of the channel bandwidth is according to a permutational method for subchannelization of the OFDMA wideband channel.

8. The method according to claim 1, wherein the assignment of the remaining channel capacity to the second classified users is based upon proportional fairness.

9. The method according to claim 8, wherein the proportional fairness is based upon maximizing sum of logarithms of prior transmission rates of the second classified users.

10. The method according to claim 1, wherein the transmission of the data to the user comprises quantizing and reshuffling the channel bandwidth and/or SINR based upon resulting bandwidth values being closest integer multiples of predetermined subchannel bandwidth, and SINR values being closest ones in a predetermined set of SINR threshold values corresponding to predetermined modulation and coding pairs.

11. The method according to claim 2, wherein the non-elastic and/or quasi-elastic data traffic types have variable rates according to prior transmission rates.

12. The method according to claim 1, wherein in case the users are classified only as second classified users, the USV is calculated based upon the capacity of the wireless channel and the prior transmission rate.

13. A method of allocating Orthogonal Frequency-Division Multiple Access (OFDMA)-based wireless data communication traffic resources of a wireless channel in a downlink transmission direction by a base station computing device in a wireless communication cell, comprising:
partitioning Quality of Service (QoS) of the wireless data communication traffic into a first data traffic class subject to a minimally required constant throughput and stringent delay constraint, and a second data traffic class not subject to constant throughput constraint;
dynamically allocating bandwidth while maintaining equal transmission power, for each user at each time slot in the first data traffic class;
dynamically and jointly allocating bandwidth and transmission power for each user at each time slot in the second data traffic class; and
wirelessly transmitting the first and second data traffic classes, according to the dynamic allocations.

14. The method according to claim 13, wherein for each user at each time slot in the first data traffic class, selecting users according a user satisfaction value (USV) based upon a packet delay, capacity of the wireless channel, data transmission rate requirement based upon the QoS and prior transmission rate.

15. The method according to claim 14,
wherein the QoS specification specifies elastic data traffic type without a minimum transmission rate requirement, quasi-elastic data traffic type with a minimum rate requirement and some delay constraints, and non-elastic data traffic type with a minimum rate requirement and a strict delay constraint, and
wherein the first classified users require non-elastic and/or quasi-elastic data traffic type and the second classified users require quasi-elastic and/or elastic data traffic type.

16. The method according to claim 15, wherein the non-elastic data traffic is voice data, quasi-elastic data traffic is one or more of video streaming or File Transfer Protocol (FTP) data, and elastic data traffic is Web site data.

17. An apparatus allocating Orthogonal Frequency-Division Multiple Access (OFDMA)-based wireless data communication resources of a wireless channel in a wireless communication cell in a downlink transmission direction, comprising:
a computer readable recording medium storing a Quality of Service (QoS) specification; and
a controller
classifying users into first and second classified users based upon the Quality of Service (QoS) specification;
for each user at each time slot selecting users according to a user satisfaction value (USV) based upon a packet delay, capacity of the wireless channel, data transmission rate requirement based upon the QoS and prior transmission rate;
calculating a minimum required transmission rate in the time slot for the first classified users from the selected users;
assigning the channel bandwidth while maintaining equal transmission power, satisfying the minimum required transmission rate to the selected first classified users;
assigning remaining of the channel bandwidth and transmission power to the second classified users of the selected users; and
wirelessly transmitting data to the users including the first and second classified users according to the assigning of the channel bandwidth.

18. The apparatus according to claim 17,
wherein the QoS specification specifies elastic data traffic type without a minimum transmission rate requirement, quasi-elastic data traffic type with a minimum rate requirement and some delay constraints, and non-elastic data traffic type with a minimum rate requirement and a strict delay constraint, and
wherein the first classified users require non-elastic and/or quasi-elastic data traffic type and the second classified users require quasi-elastic and/or elastic data traffic type.

19. The apparatus according to claim 18, wherein the non-elastic data traffic is voice data, quasi-elastic data traffic is one or more of video streaming or File Transfer Protocol (FTP) data, and elastic data traffic is Web site data.

20. A computer readable recording medium for allocating Orthogonal Frequency-Division Multiple Access (OFDMA)-based wireless data communication resources of a wireless channel in a downlink transmission direction by controlling a base station computing device in a wireless communication cell to perform operations comprising:
classifying users into first and second classified users based upon a Quality of Service (QoS) specification;
for each user at each time slot selecting users according to a user satisfaction value (USV) based upon a packet delay, capacity of the wireless channel, data transmission rate requirement based upon the QoS and prior transmission rate;
calculating a minimum required transmission rate in the time slot for the first classified users from the selected users;
assigning the channel bandwidth while maintaining equal transmission power, satisfying the minimum required transmission rate to the selected first classified users;
assigning remaining of the channel bandwidth and transmission power to the second classified users of the selected users; and
wirelessly transmitting data to the users including the first and second classified users according to the assigning of the channel bandwidth.
